(19) United States
(12) Patent Application Publication
(10) Pub. No.: US 2026/0110877 A1
(43) Pub. Date: Apr. 23, 2026

(54) OPTICAL DEVICE AND FIXING APPARATUS FOR OPTICAL COMPONENT

(71) Applicant: Syncell (Taiwan) Inc., Taipei City (TW)

(72) Inventors: Chang-Hsuan CHU, Taipei City (TW); Wei-Cheng HUANG, Taipei City (TW)

(21) Appl. No.: 19/366,071

(22) Filed: Oct. 22, 2025

Related U.S. Application Data
(60) Provisional application No. 63/710,554, filed on Oct. 22, 2024.

(51) Int. Cl. G02B 7/198; G02B 21/26

(52) U.S. Cl. CPC G02B 7/198; G02B 21/26

(57) ABSTRACT

An optical device includes a base, a cover, and an optical component. The base has a first arc-shaped recess. The cover is connected to the base and has a second arc-shaped recess, and the first arc-shaped recess and the second arc-shaped recess are configured to align with each other and collectively define a fixing hole. The optical component is between the base and the cover, in which the optical component has a mirror and a holder which is connected to the mirror, and the holder is fixed in the fixing hole.

### CLAIM OF PRIORITY

This application claims priority to U.S. Provisional Patent Application No. 63/710,554, filed Oct. 22, 2024, titled “DELICATE ADJUSTMENT DESIGN FOR SCANNING MIRRORS”, which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The present disclosure relates to an optical device and fixing apparatus for fixing optical components. More particularly, the present disclosure relates to an optical device which has a fixing apparatus for fixing a mirror and a microscope-based system with image-guided microscopic illumination using such fixing apparatus.

### BACKGROUND

There are needs in illuminating patterns on samples (e.g. biological samples) at specific locations. Processes such as photobleaching of molecules at certain subcellular areas, photoactivation of fluorophores at a confined location, optogenetics, light-triggered release of reactive oxygen species within a designated organelle, or photoinduced labeling of proteins in a defined structure feature of a cell all require pattern illumination. For certain applications, the pattern of the abovementioned processes may need to be determined by a microscopic image. Some applications further need to process sufficient samples, adding the high-content requirement to repeat the processes in multiple regions. Systems capable of performing such automated image-based localized photo-triggered processes are rare.

Systems for illuminating patterns on samples include many optical elements, such as a lens, a mirror, or an optical detector that may need to be fixed. Further, these optical elements need adjustments for optical path alignment during the initial set up or subsequent calibrations. However, all the currently available fixing devices on the market are made as a one-piece molding. The one-piece molding design utilizes an integrated C-shaped structure with a slot opening at the open end, but this kind of design requires the optical component being inserted into the designated fixing hole for fixing, with sometimes part of the optical component, such as a mirror passing through the slot opening. The user must handle it with extreme care to avoid scratching the optical elements (such as a mirror) against the slot opening. In addition, after secured for fixing, the optical component is frequently found stuck by the one-piece molding design fixing device when re-adjustment is needed.

There remains a need for an adjustable optical fixing apparatus that not only prevents damage to delicate optical elements during installation and removal, but also enables easy re-adjustment and reliable alignment during setup and calibration.

### SUMMARY OF THE DISCLOSURE

The present disclosure provides an optical device includes a base, a cover, and an optical component. The base has a first arc-shaped recess. The cover is connected to the base and has a second arc-shaped recess, and the first arc-shaped recess and the second arc-shaped recess are configured to align with each other and collectively define a fixing hole. The optical component is between the base and the cover, in which the optical component has a mirror and a holder which is connected to the mirror, and the holder is fixed in the fixing hole.

The present disclosure also provides a fixing apparatus for holding an optical component which includes a base and a cover. The base has a first arc-shaped recess. The cover is connected to the base and has a second arc-shaped recess, and the first arc-shaped recess and the second arc-shaped recess are configured to align with each other and collectively define a fixing hole.

In summary, the fixing apparatus primarily includes a base and covers for holding galvanometer scanning mirrors. Such design facilitates smoother adjustments of the galvanometer scanning mirrors and prevents the scanning mirrors from getting stuck, thus providing significant convenience to users. A user can place an optical component onto the base, position the cover on the base, and secure them with screws. This action reduces the risk of scratches during installation compared to traditional one-piece C-shaped designs. The protrusion portions ensure that the contact area is not the entire circumference for avoiding jamming during adjustments due to reduced friction.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of an optical device which has a fixing apparatus according to some embodiments of the present disclosure.

FIG. 2 is a perspective view of the fixing apparatus in FIG. 1.

FIG. 3 is an exploded view of the fixing apparatus in FIG. 1.

FIG. 4 is a side view of the fixing apparatus in FIG. 1.

FIG. 5 is an enlarged schematic view of a part of the fixing apparatus in FIG. 4 according to the dotted rectangle

FIG. 6 is an exploded view of a fixing apparatus according to another embodiments of the present disclosure.

FIG. 7 is a side view of the fixing apparatus in FIG. 6.

FIG. 8 is an enlarged schematic view of a part of the fixing apparatus in FIG. 7 according to the dotted rectangle

FIG. 9 represents a schematic diagram of an imaging-guided microscope-based system.

FIG. 10 depicts the detailed components of the imaging-guided microscope-based system of FIG. 9.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

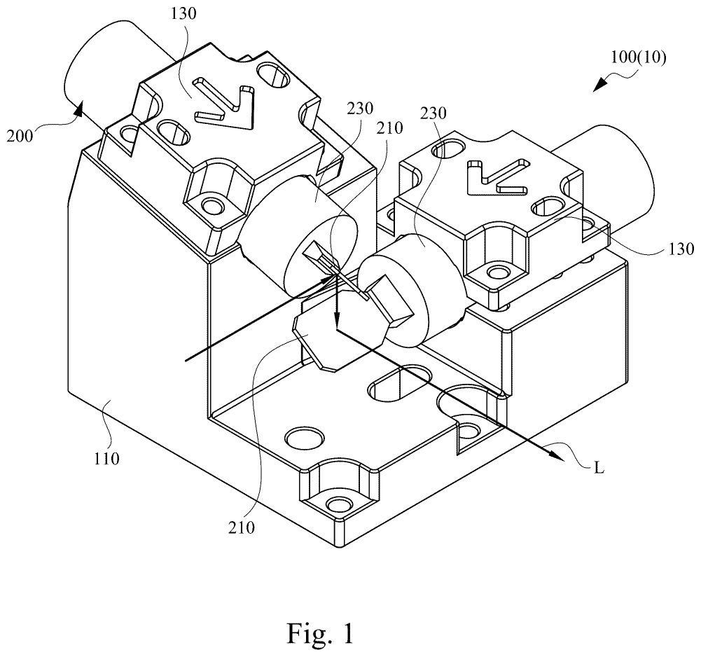

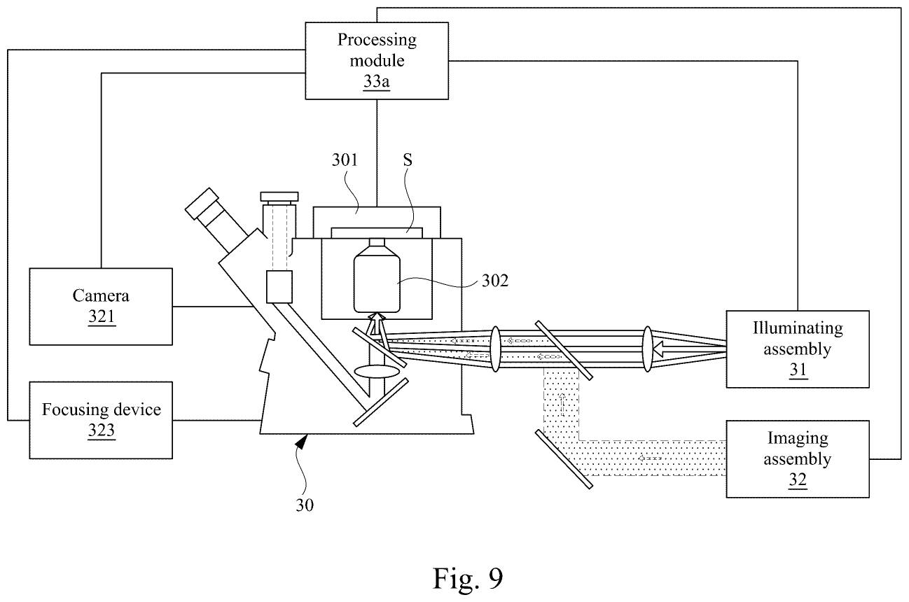

As shown in FIG. 1, an optical device 10 includes one or more optical components 200. In some embodiments, the optical device 10 includes a fixing apparatus 100 and a pair of optical components 200 which are configured to direct a light beam L along different axes. Each optical component 200 includes a mirror 210 and a holder 230 connected to the mirror 210, and the holder 230 is clamped by the fixing apparatus 100. In one embodiment, the optical device 10 is a galvanometer (galvo) scanning device which may be utilized in an imaging-guided microscope-based system as shown in FIG. 9, and the optical components 200 can be galvo scanning mirrors.

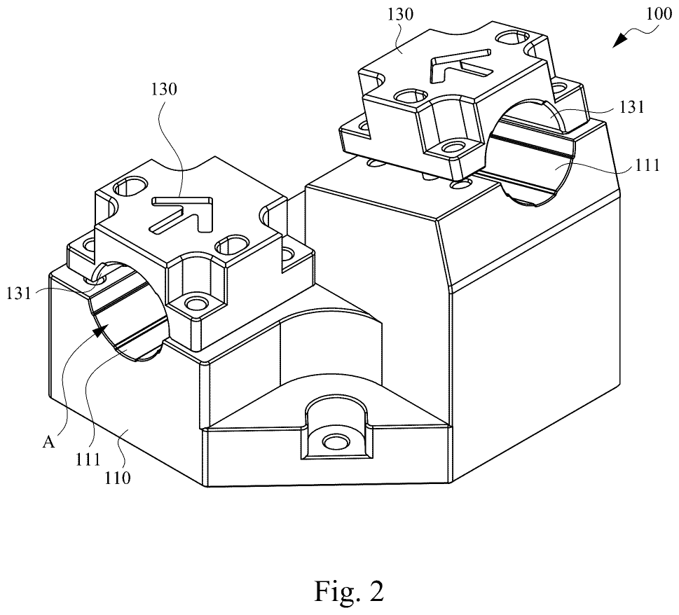

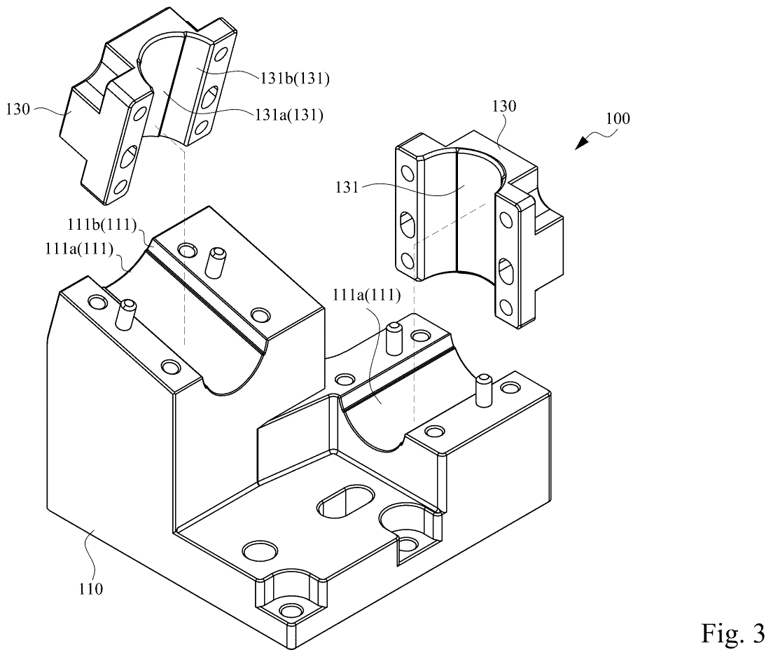

Please refer to FIGS. 1-3. In some embodiments of the present disclosure, the fixing apparatus 100 includes a base 110 and two covers 130. The base 110 and covers 130 can be made of metal, alloy or plastic. The base 110 has a first arc-shaped recess 111, and each cover 130 has a second arc-shaped recess 131. When the base 110 and each cover 130 are assembled and connected, the first arc-shaped recess 111 and the second arc-shaped recess 131 are designed to be substantially coaxially aligned. Therefore, the first arc-shaped recess 111 and the second arc-shaped recess 131 may be coaxially arranged for collectively defining a fixing hole A, such that the holder 230 of the optical component 200 can be disposed in and secured within this fixing hole A. In one embodiment, the fixing hole A is substantially a cylindrical hole, with a cross-sectional view substantially formed as a circle. It is easy to assemble the separable base 110 and each cover 130, and a user can place the holder 230 onto the first arc-shaped recess 111 of the base 110 and then position each cover 130 over the base 110 and holder 230. Thereafter, the base 110 and each cover 130 are firmly fixed and connected, for example, with one or more screws. Compared with directly inserting the optical component 200 into a one-piece C-shaped clamp, the risk of damaging the optical component 200 is significantly reduced in this case.

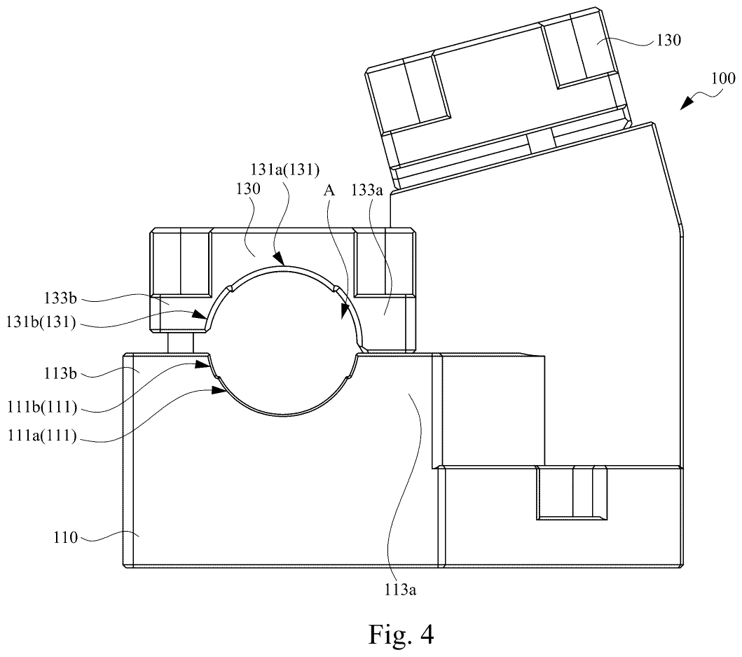

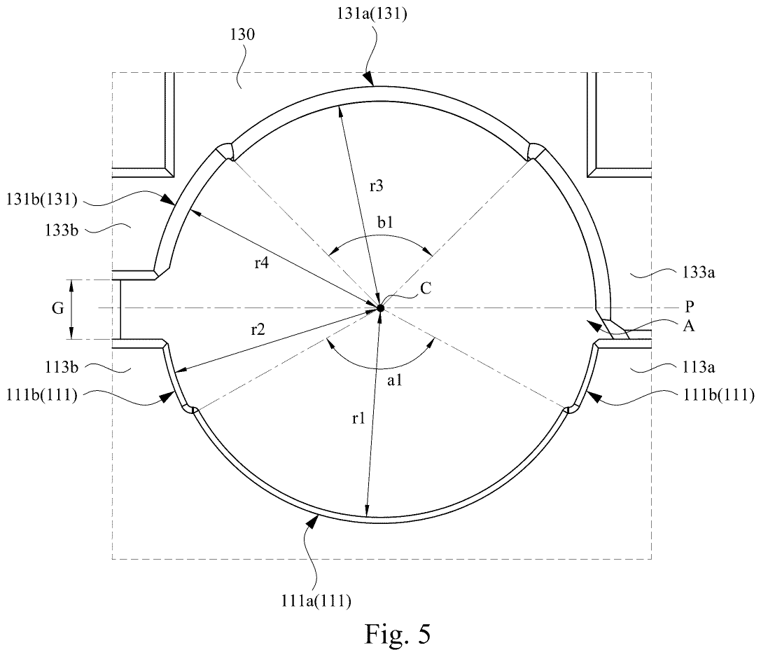

Please refer to FIGS. 4-5. In some embodiments of the present disclosure, the first arc-shaped recess 111 of the base 110 includes at least one protrusion portion 111a and at least one interval portion 111b. The protrusion portion 111a is configured to be in direct contact with the holder 230. The interval portion 111b adjoins the protrusion portion 111a and is configured to be spaced apart from the holder 230 to provide a gap between the interval portion 111b and the holder 230. In a specific embodiment, the first arc-shaped recess 111 of the base 110 includes one protrusion portion 111a and two interval portions 111b, while the protrusion portion 111a is disposed between the two interval portions 111b. The protrusion portion 111a subtends an angle a1 ranging from 100 degrees to 140 degrees relative to the center C of the circle in the cross-sectional view (as mentioned above and shown in FIG. 5) of the fixing hole A. Preferably, protrusion portion 111a subtends the angle a1 ranging from 110 degrees to 130 degrees relative to the center C of the fixing hole A. Since the first arc-shaped recess 111 of the base 110 is partially in contact with the optical component 200 via the protrusion portion 111a while the two interval portions 111b are not, the friction between the fixing apparatus 100 and the optical component 200 is reduced, thereby facilitating the adjustment of the optical component 200. In particular, during re-adjustment, it effectively prevents the optical component 200 from getting stuck in the one-piece molded design of the fixing device as mentioned above.

The second arc-shaped recess 131 of the cover 130 includes at least one protrusion portion 131a and at least one interval portion 131b. The protrusion portion 131a is configured to be in contact with the holder 230, and the interval portion 131b is configured to be spaced apart from the holder 230 to provide a gap between the interval portion 131b and the holder 230. In one embodiment, the second arc-shaped recess 131 of the cover 130 includes one protrusion portion 131a and two interval portions 131b, and the protrusion portion 131a is disposed between the two interval portions 131b for decreasing the friction between the fixing apparatus 100 and the optical device 200. In some embodiments of the present disclosure, the protrusion portion 131a of the second arc-shaped recess 131 subtends an angle b1 ranging from 70 to 110 degrees relative to the center C of the circle, thereby optimizing clamping stability and adjustability. Preferably, the protrusion portion 131a subtends the angle b1 ranging from 80 to 100 degrees relative to the center C.

The design for the protrusion portion and interval portion of the arc-shaped recesses of the base 110 and the cover 130, and the associated angles, may be exchangeable. That is, in an alternative embodiment, the protrusion portion 111a subtends an angle a1 ranging from 70 degrees to 110 degrees relative to the center C of the fixing hole A. Preferably, the protrusion portion 111a subtends the angle ranging a1 from 80 degrees to 100 degrees relative to the center C of the fixing hole A. The protrusion portion 131a of the second arc-shaped recess 131 subtends an angle b1 ranging from 100 degrees to 140 degrees relative to the center C. Preferably, the protrusion portion 131a of the second arc-shaped recess 131 subtends the angle b1 ranging from 110 degrees to 130 degrees relative to the center C. The present disclosure is not limited thereto.

The protrusion portion 111a can define a first virtual circle with a shorter radius r1, while the interval portions 111b can define a second virtual circle with a longer radius r2 greater than the shorter radius r1. The first virtual circle and the second virtual circle can have a same center C. Moreover, the protrusion portion 131a can define a third virtual circle with a shorter radius r3, while the interval portions 131b can define a fourth virtual circle with a longer radius r4 greater than the shorter radius r3. Moreover, the third virtual circle and the fourth virtual circle can have the same center C. In one embodiment, the shorter radius r3 is equal to or greater than the shorter radius r1, but the present disclosure is not limited thereto. The shorter radius r1 and the shorter radius r3 range from 3 mm to 25 mm, and the longer radius r2 and the longer radius r4 also range from 3 mm to 25 mm. Moreover, a difference between the shorter r1 and the longer radius r2 is from 0.01 mm to 0.5 mm (e.g., a difference between 0.05 mm and 0.2 mm), and a difference between the shorter radius r3 and the longer radius r4 is from 0.01 mm to 0.5 mm (e.g., a difference between 0.05 mm and 0.2 mm). The present disclosure is not limited thereto.

Referring to FIGS. 4 and 5, the base 110 has a first extension portion 113a and a second extension portion 113b, and the first arc-shaped recess 111 is between the first extension portion 113a and the second extension portion 113b. In addition, the cover 130 has a first extension portion 133a and a second extension portion 133b, and the second arc-shaped recess 131 is between the first extension portion 133a and the second extension portion 133b. When the base 110 and the cover 130 are assembled, the first extension portion 133a is in direct contact with a top surface of the first extension portion 113a as a support or pivot. The second extension portion 133b is designed to be spaced apart from the second extension portion 113b of the base 110 to form a gap G. When screws are tightened to secure the cover 130 to the base 110, this configuration ensures that pressure is applied to the holder 230 (referring to FIG. 1) via the protrusion portion 111a and the protrusion portion 131a. In one embodiment, the gap G is equal to or greater than 0.1 mm and equal to or less than 30 mm. For instance, the gap G is about from 1 mm to 4 mm (e.g., 2 mm). A top surface of the second extension portion 113b is aligned with the center C of the fixing hole A in a horizontal direction or lower than the center C of the fixing hole A. A bottom surface of the second extension portion 133b is aligned with the center C of the fixing hole A in the horizontal direction or higher than the center C of the fixing hole A. In some embodiments, a vertical distance from the top surface of the second extension portion 113b to a virtual horizontal plane P passing the center C (e.g., 1 mm) is equal to a vertical distance from the bottom surface of the second extension portion 133b to the virtual horizontal plane P passing the center C (e.g., 1 mm). A contact surface between the first extension portion 113a and the first extension portion 133a is lower than the center C or aligned with the center C in a horizontal direction. In other embodiments, the contact surface between the first extension portion 113a and the first extension portion 133a is higher than the center C. In other embodiments, a vertical distance from the top surface of the second extension portion 113b to a virtual horizontal plane P passing the center C is greater than a vertical distance from the bottom surface of the second extension portion 133b to the virtual horizontal plane P passing the center C. Moreover, the contact surface between the first extension portion 113a and the first extension portion 133a is lower than the center C (e.g., 1 mm) to decrease the friction between the fixing apparatus 100 and the optical device 200, and to prevent the optical device 200 from getting stuck in the fixing hole A, and the present disclosure is not limited thereto.

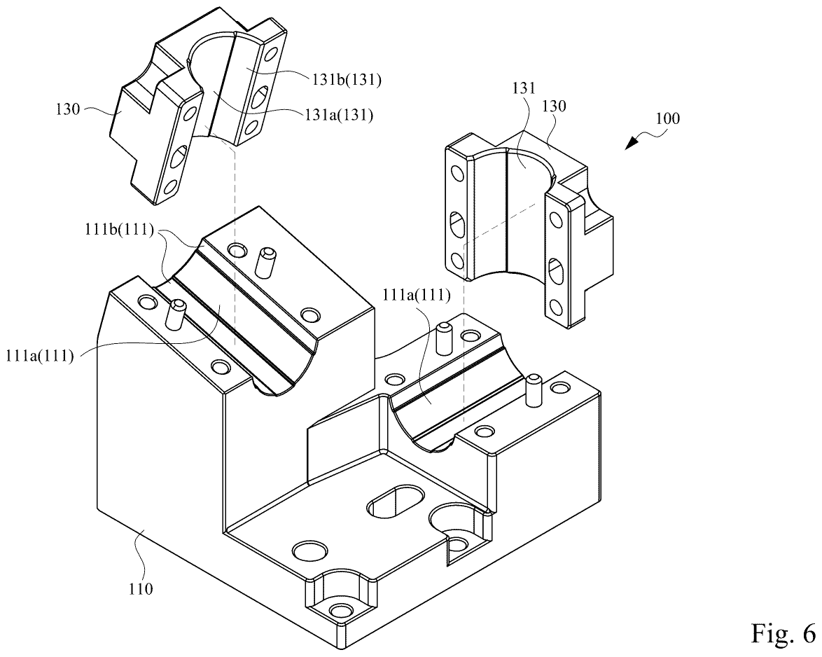

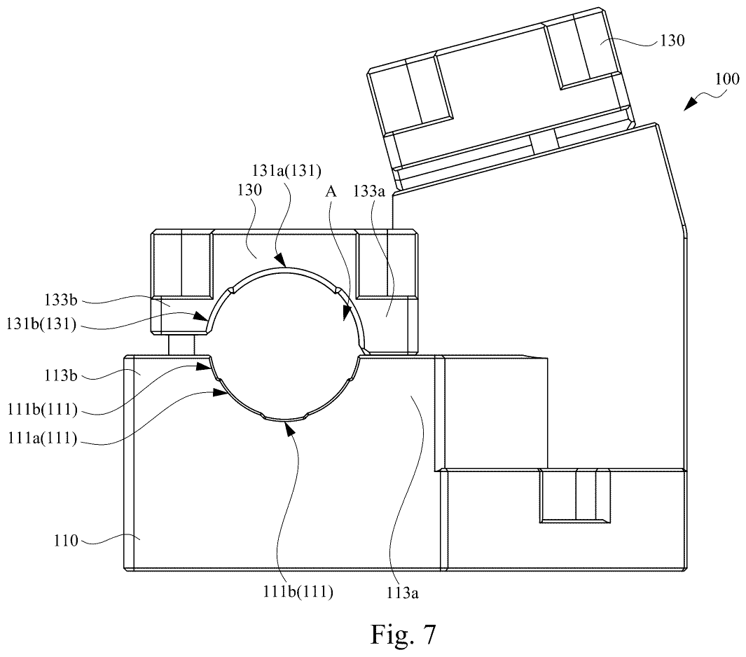

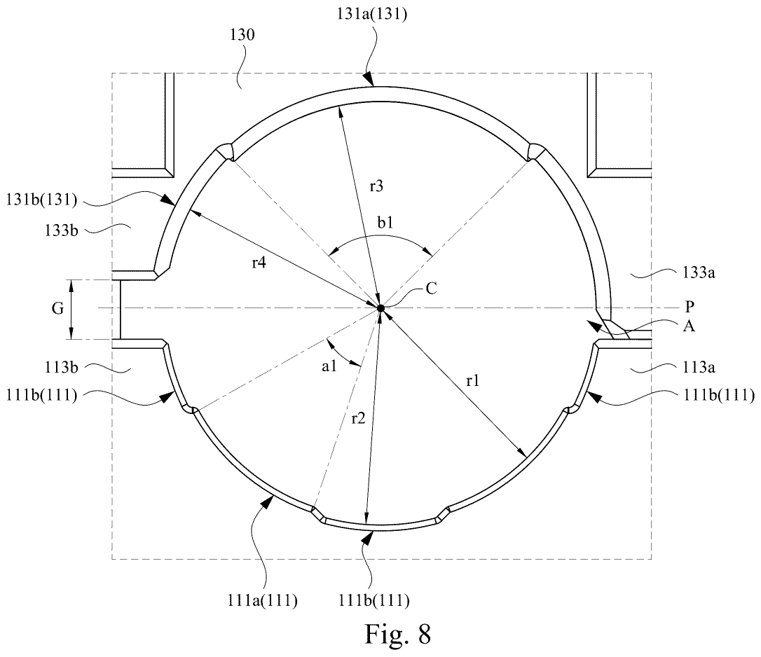

Please refer to FIGS. 6-8. In some embodiments of the present disclosure, the first arc-shaped recess 111 of the base 110 includes two protrusion portions 111a and three interval portions 111b (i.e., one first interval portion 111b and two second interval portions 111b). The first interval portion 111b is disposed between the two second protrusion portions 111a, and each of the protrusion portions 111a is disposed between the first interval portion 111b and one of the two second interval portions 111b. It decreases the contact area to the protrusion portions 111a, thereby reducing friction and preventing jamming or getting stuck. An angle a1 subtended by each protrusion portion 111a of the first arc-shaped recess 111 ranges from 30 degrees to 70 degrees. Preferably, the protrusion portion 111a subtends the angle ranging a1 from 40 degrees to 60 degrees relative to the center C of the fixing hole A. An angle subtended by the first interval portion 111b of the first arc-shaped recess 111 relative to the center C of the fixing hole A may also range from 30 degrees to 70 degrees, and preferably, from 40 degrees to 60 degrees.

The protrusion portions 111a can define a first virtual circle with a shorter radius r1, while the interval portions 111b can define a second virtual circle with a longer radius r2 greater than the shorter radius r1. The first virtual circle and the second virtual circle can have the same center C. Moreover, the protrusion portion 131a can define a third virtual circle with a shorter radius r3, while the interval portions 131b can define a fourth virtual circle with a longer radius r4 greater than the shorter radius r3. Moreover, the third virtual circle and the fourth virtual circle can have the same center C. Specifically, the shorter radius r3 is equal to or greater than the shorter radius r1, but the present disclosure is not limited thereto. The shorter radius r1 and the shorter radius r3 range from 3 mm to 25 mm, and the longer radius r2 and the longer radius r4 also range from 3 mm to 25 mm. Moreover, a difference between the shorter radius r1 and the longer radius r2 is from 0.01 mm to 0.5 mm (e.g., a difference between 0.05 mm and 0.2 mm), and a difference between the shorter radius r3 and the longer radius r4 is from 0.01 mm to 0.5 mm (e.g., a difference between 0.05 mm and 0.2 mm). The present disclosure is not limited thereto.

In some embodiments of the present disclosure, the second arc-shaped recess 131 includes two protrusion portions 131a configured to be in contact with the holder 230 and one first interval portion 131b between the two protrusion portions 131a and configured to be spaced apart from the holder 230, such that a gap is between the first interval portion 131b and the holder 230. Moreover, the second arc-shaped recess 131 further includes another two second interval portions 131b, in which each of the protrusion portions 131a is disposed between the first interval portion 131b and one of the two second interval portions 131b. The present disclosure is not limited thereto.

Please refer to FIGS. 1, 9-10. In some embodiments of the present disclosure, the optical device 10 may be incorporated into a microscope 30 for image-guided microscopic illumination in an imaging-guided microscope-based system. As shown in FIG. 9, the microscope 30 includes a stage 301 equipped with an objective 302, and the stage 301 is configured to hold a sample S. The microscope 30 further includes an illuminating assembly 31, an imaging assembly 32, and a processing module 33a. The imaging assembly 32 includes a camera 321, an imaging light source 322, a focusing device 323, and a first shutter 324, and the focusing device 323 is coupled to the camera 321 to facilitate autofocusing during imaging of the sample S. The illuminating assembly 31 includes an illumination light source 311, such as a laser, and a pattern illumination device 317 for illuminating interested regions of the sample S.

The pattern illumination device 317 may include a second shutter 312, a lens module 313, which includes a relay lens 313a and a relay lens 313b, and a quarter wave plate 313c, at least a pair of scanning mirrors 315, and a scan lens 316. Please referring to FIGS. 1, 9 and 10, the optical device 10 can be used to securely hold and position the pair of scanning mirrors 315 (corresponding to the optical components 200), such as galvanometer (galvo) scanning mirrors for X-axis and Y-axis control, ensuring precise alignment of the light beam during pattern illumination. The processing module 33a, which may be a computer or workstation, is coupled to the imaging assembly 32 and the illuminating assembly 31 to control operations, and a signal converter 37 is also coupled to the processing module 33a to interface between the processing module 33a and other components.

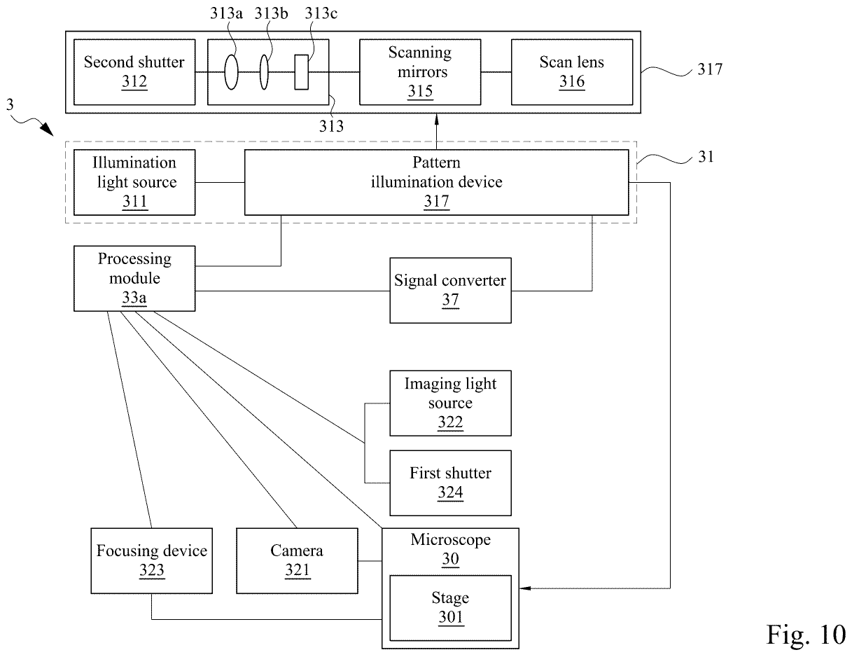

As shown in FIG. 10, the processing module 33a controls the imaging assembly 32 to acquire images of the sample S via the camera 321, processes the images in real-time based on predefined criteria to identify the interested regions, thereby obtaining coordinate information for those regions. Subsequently, the processing module 33a directs the pattern illumination device 317 in the illuminating assembly 31 to illuminate the interested regions according to the coordinates. The optical device 10 provides stable and adjustable fixation for the scanning mirrors 315 within the pattern illumination device 317, thereby facilitating high-speed consecutive illumination, minimizing risks of misalignment, and preventing the scanning mirrors 315 from damaging during setup and calibration.

In summary, the fixing apparatus primarily includes a base and covers for holding galvanometer scanning mirrors. Such design facilitates smoother adjustments of the galvanometer scanning mirrors and prevents the scanning mirrors from getting stuck, thus providing significant convenience to users. A user can place an optical component onto the base, position the cover on the base, and secure them with screws. This action reduces the risk of scratches during installation compared to traditional one-piece C-shaped designs. The protrusion portions ensure that the contact area is not the entire circumference for avoiding jamming during adjustments due to reduced friction. In addition, since the cover mainly serves as the part subjected to stress and tightening, while the base substantially functions as a carrier for supporting the fixed object, the radius of the circle in the cross-sectional view of the fixing hole of the base can be designed to match, or be only slightly larger than, the radius of the fixed object. Accordingly, the position of the optical component after fixation, as well as the optical path, becomes more predictable and easier to control.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical device, comprising:
a base having a first arc-shaped recess;
a cover connected to the base and having a second arc-shaped recess, wherein the first arc-shaped recess and the second arc-shaped recess are configured to align with each other and collectively define a fixing hole; and
an optical component disposed between the base and the cover, wherein the optical component has a mirror and a holder which is connected to the mirror and disposed in the fixing hole.

2. The optical device of claim 1, wherein the first arc-shaped recess and the second arc-shaped recess are configured to be coaxially arranged.

3. The optical device of claim 1, wherein the first arc-shaped recess of the base comprises:
at least one protrusion portion configured to be in contact with the holder; and
at least one interval portion adjoining the protrusion portion and configured to be spaced apart from the holder.

4. The optical device of claim 3, wherein the at least one interval portion comprises two interval portions, and wherein the protrusion portion is disposed between the two interval portions.

5. The optical device of claim 3, wherein a cross-sectional view of the fixing hole is substantially a circle, and an angle subtended by the protrusion portion of the first arc-shaped recess of the base relative to a center of the circle ranges from 100 degrees to 140 degrees.

6. The optical device of claim 3, wherein a cross-sectional view of the fixing hole is substantially a circle, and the at least one protrusion portion defines a first virtual circle with a shorter radius, the at least one interval portion defines a second virtual circle with a longer radius greater than the shorter radius, and the first virtual circle and the second virtual circle have the same center as the center of the circle of the fixing hole.

7. The optical device of claim 1, wherein the second arc-shaped recess of the cover comprises:
at least one protrusion portion configured to be in contact with the holder; and
at least one interval portion adjoining the protrusion portion and configured to be spaced apart from the holder.

8. The optical device of claim 7, wherein the at least one interval portion comprises two interval portions, and the protrusion portion is disposed between the two interval portions.

9. The optical device of claim 7, wherein a cross-sectional view of the fixing hole is substantially a circle, and an angle subtended by the protrusion portion of the second arc-shaped recess of the cover relative to a center of the circle ranges from 70 degrees to 110 degrees.

10. The optical device of claim 1, wherein the first arc-shaped recess of the base comprises:
two protrusion portions configured to be in contact with the holder; and
a first interval portion disposed between the two protrusion portions and configured to be spaced apart from the holder.

11. The optical device of claim 10, wherein the first arc-shaped recess of the base further comprises:
two second interval portions, wherein each of the protrusion portions is disposed between the first interval portion and one of the second interval portions.

12. The optical device of claim 10, wherein a cross-sectional view of the fixing hole is substantially a circle, and an angle subtended by each protrusion portion of the first arc-shaped recess of the base relative to a center of the circle ranges from 30 degrees to 70 degrees.

13. The optical device of claim 1, wherein the cover has a first extension portion configured to be in contact with the base and a second extension portion configured to be spaced apart from the base, wherein the second arc-shaped recess is disposed between the first and second extension portions.

14. The optical device of claim 13, wherein a gap between the second extension portion and the base is equal to or greater than 0.1 mm and equal to or less than 30 mm.

15. The optical device of claim 13, wherein a cross-sectional view of the fixing hole is substantially a circle, and a bottom surface of the second extension portion is aligned with or higher than a center of the fixing hole.

16. A fixing apparatus for holding an optical component, comprising:
a base having a first arc-shaped recess;
a cover connected to the base and having a second arc-shaped recess, wherein the first arc-shaped recess and the second arc-shaped recess are configured to align with each other and collectively define a fixing hole.

17. The fixing apparatus of claim 16, wherein the first arc-shaped recess and the second arc-shaped recess are configured to be coaxially arranged.

18. The fixing apparatus of claim 16, wherein at least one of the first arc-shaped recess of the base and the second arc-shaped recess of the cover comprises:
at least one protrusion portion configured to be in contact with the optical component; and
at least one interval portion adjoining the protrusion portion and configured to be spaced apart from the optical component.

19. The fixing apparatus of claim 18, wherein the at least one protrusion portion defines a first virtual circle with a shorter radius, the at least one interval portion defines a second virtual circle with a longer radius greater than the shorter radius, and the first virtual circle and the second virtual circle have the same center.

20. The fixing apparatus of claim 16, wherein the cover has a first extension portion configured to be in contact with the base and a second extension portion configured to be spaced apart from the base, wherein the second arc-shaped recess is disposed between the first and second extension portions.
